(19) United States
(12) Patent Application Publication
(10) Pub. No.: US 2006/0110613 A1
(43) Pub. Date: May 25, 2006

(54) Flame retardant metallized polyester films having anti-dripping properties

(75) Inventors: Yijun Ye, Saunderstown, RI (US); Steven Sargeant, Kingston, RI (US)

Correspondence Address: Marylou J. Lavoie, Esq. LLC, 1 Banks Road, Simsbury, CT, 06070, US

(73) Assignee: Toray Plastics (America), Inc., North Kingstown, RI (US)

(21) Appl. No.: 10/996,517

(22) Filed: Nov. 24, 2004

(51) Int. Cl. B32B 15/08; B32B 27/36

(52) U.S. Cl. 428/458; 428/480; 427/402

(57) ABSTRACT

A metallized flame retardant polyester film comprising varying levels of phosphorous in the individual film layers. The phosphorous loading disposes the minimum amount of phosphorous required to impart flame retardancy to the film. In embodiments, the film is a multi-layer film and the outer most layer or layers of the film comprise higher levels of phosphorous than then inner most layer or layers. The inner layer or layers may be phosphorous-free. The differential phosphorous loading imparts flame retardant properties to the film while minimizing the use of costly phosphorous.

### TECHNICAL FIELD

The present disclosure relates to polyester films and more particularly relates to anti-dripping metallized flame retardant polyester films and methods for preparing the films.

### BACKGROUND

Flame retardant thermoplastic resins have been widely used, particularly in the electric and electronics industry. For many applications, a plastic is deemed acceptable for use as part of a device or appliance with respect to its flammability if it achieves a UL 94 (Underwriters Laboratory®) flammability test rating of V-0 for stock shaped products (sheet, rod, tube and film) or VTM-0 for thin materials. Briefly, a UL 94 flammability rating of VTM-0 means that using a vertical burn test, burning stops within 10 seconds after two applications of three seconds each of a flame to a test specimen. No flaming drips are allowed. Traditionally, halogenated compounds have been employed as flame-retardants in combination with one or more synergists to achieve high levels of safety against flames (flame retardancy). Halogen based compounds are very effective in imparting flame retardancy, especially when used in combination with a synergist such as antimony oxide.

The tendency for most thermoplastic resins to burn is one problem in the art. Further, under intensive heat, burning plastics also melt and decompose. The resultant burning polymer drips, thereby causing additional problems. Therefore, the UL-94 standard includes dripping criteria. In order to achieve a UL-94 V-0 (or VTM-0) rating, there cannot be dripping that causes cotton positioned 300 millimeters below the test subject to be ignited by flaming particles or drops. For most molding applications, a fluorinated polyolefin has been traditionally used to prevent dripping. In addition, grafting or cross-linking agents have been used for this purpose.

By using special catalysts during polymerization, polyethyleneterephthalate (PET) can be prepared to attain a moderate flame retardancy of V-2. To obtain a V-0 rating, various flame retardants must be compounded into the PET. For thin film, a VTM-2 rating can be obtained when the film is thick enough and/or when the molecular weight of the PET is high enough.

U.S. Pat. No. 6,136,892 to Yamauchi et al. discloses in the Abstract thereof a flame retardant resin composition including 100 parts by weight of component (A) or (B) and 0.01 to 30 parts by weight of red phosphorus (C) shows excellent flame retardancy even if the molding obtained from it is thin, and is excellent in mechanical properties, wet heat resistance and electric properties, being suitable for mechanical parts, electric and electronic parts, automobile parts, and housings and other parts of office automation apparatuses and household electric appliances. Component (A) may be a thermoplastic resin polyethylene terephthalate and ethylene terephthalate copolymers, and polyethylene terephthalate and/or ethylene terephthalate copolymer, and component (B) may be a thermoplastic resin selected from

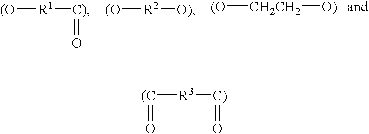

wherein R¹, R², and R³ are divalent aromatic residues.

U.S. Pat. No. 4,104,259 to Kato et al. in the Abstract thereof a fireproof linear aromatic polyester having a high stability to ultraviolet rays and heat contains a unit of the formula:

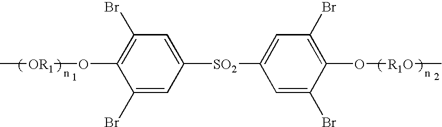

wherein R₁ and R₂ are each a straight or branched alkylene group having 1 to 5 carbon atoms and η₁ and η₂ are each an integer of from 1 to 4. The addition of an organic pentavalent phosphorus compound may improve the fireproof properties of products prepared from said polyesters.

U.S. Pat. No. 4,517,355 to Mercati et al. discloses in the Abstract thereof a flameproof linear polyester is described containing, copolymerized in the molecule, a phosphorus compound of the formula:

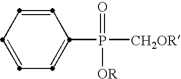

where R is a hydrogen atom, an alkyl group with 1 to 4 carbon atoms or a hydroxyalkyl group, and R′ is a hydrogen atom, a hydroxyalkyl group or the group —(CH₂CH₂O)_{η}H, where η varies from 1 to 4. Said linear polyester is prepared by firstly forming a low molecular weight precondensate from a dicarboxylic aromatic acid (or a relative lower alkyl diester) and an alkylene glycol, and then polycondensing in the presence of said phosphorus compound, in such a quantity as to obtain a content of phosphorus (expressed as the metal) in the linear polyester of between 0.4 and 0.8% by weight. The linear polyester thus obtained can be formed into articles such as fibres, film, sheets and other articles which, besides being flameproof, possess improved dyeing characteristics. A process is also described for preparing the phosphorus compounds corresponding to the aforesaid general formula, where R is hydrogen or an alkyl group containing 1 to 4 carbon atoms, and R′ is hydrogen. Said phosphorus compounds are prepared by reacting phenylphosphinic acid or ester with paraformaldehyde, at a temperature of between 60° and 150° C.

U.S. Pat. No. 5,650,531 discloses in the Abstract thereof the synthesis of a non-halogen flame retardant oligomer containing highly pendant phosphorus moieties is disclosed. Diols, unsaturated double bond-containing dicarboxylic acids or acid anhydrides and saturated dicarboxylic acids or acid anhydrides are first esterified to form an oligomeric unsaturated polyester, and then a phosphorus-containing compound is grafted onto the oligomeric unsaturated polyester through addition reaction in the presence of a selected metal complex catalyst.

U.S. Pat. No. 4,157,436 to Endo et al. describes in the Abstract thereof the present invention relates to a flame retardant polyester having a phosphorus atom content of 500-50,000 ppm, which polyester contains a flame-retarding amount of a phosphorus containing compound represented by the following general formula:

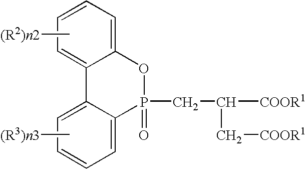

wherein each of R′ is a hydrogen atom or hydrocarbon group having 1-10 carbon atoms which may contain a hydroxyl group, and both R¹'s may together form a dehydrated ring when both of R¹'s represent hydrogen atoms, each of R² and R³ is a member selected from the group consisting of halogen atoms and hydrocarbon groups having 1-10 carbon atoms, and each of n2 and n3 is an integer of 0-4. Polyesters containing the claimed phosphorus containing compounds are characterized by exhibiting excellent flame retardancy and at the same time, the physical properties of the polyesters are not impaired by incorporation of the phosphorus compound therein.

Published United States Patent Application 20040097621 A1 of William Alasdair et al. discloses in the Abstract thereof the use of copolyester of one or more dicarboxylic acid(s), one or more diol(s) and one or more copolymerisable phosphorous-containing flame retardant compound(s) wherein the phosphorus atom(s) are present in the copolyester in a group pendant to the polymer backbone, for the purpose of providing thermal stability and flame retardancy to an article made from said copolyester.

Published United States Patent Application 20030054169 A1 of Ursula Murschall et al. describes in the Abstract thereof biaxially oriented, co-extruded polyester films comprising a base layer consisting of at least 90 wt. % thermoplastic polyester, preferably polyethylene terephthalate (PET), at least one sealable outer layer and a second non-sealable outer layer and, optionally, other intermediate layers, in addition to at least one UV absorber, preferably hydroxy benzotriazole and triazine, and at least one flame-retardant agent, preferably organic phosphorous compounds. The inventive films are characterized by low inflammability, high UV stability, no embrittlement when subjected to thermal stress and a surface which is devoid of troublesome opacity. They are suitable for a multiplicity of uses both indoors and outside. The outer layers contain anti-blocking agents such as silicic acid having an average particle diameter of preferably less than 50 nm and/or more than 2 mμm. Preferably, the sealable outer layer consists of a copolyester which is made of ethylene terephthalate and ethylene isophthalate units.

U.S. Pat. No. 6,730,406 to Murschall et al. describes in the Abstract thereof a co-extruded, biaxially oriented polyester film consisting of a base layer and at least one outer layer. The film contains at least one flame-retardant agent, at least one UV-stabilizer and has a matt outer layer which contains a mixture and/or a blend of two components (I) and (II), whereby component (I) is substantially a polyethylene terephthalate homopolymer, or a polyethylene terephthalate copolymer, or a mixture of polyethylene terephthalate homopolymers or polyethylene terephthalate copolymers, and component (II) is a polymer containing at least one sulphonate group.

U.S. Pat. No. 4,310,587 to Beaupre describes in the Abstract thereof a fire resistant, flexible vapor barrier sheet comprising a laminate of a metallized substrate sheet and a radiation cured resin layer containing an inorganic pigment. The vapor barrier sheet can be laminated to one side of an insulation bat to provide an attractive, fire resistant insulation product for use in walls of metal buildings and the like.

Published United States Patent Application 20030031874 A1 of Peter Todd Valinski et al. describes in the Abstract thereof materials for flame retardant optical films, including adhesives and coatings for fabricating flame retardant composite films useful for window shades, e.g., for solar control window shade, comprise chemically bonded flame retardant components, e.g., tetrabromobisphenol A and bis(2-chloroethyl) vinyl phosphonate. Preferred adhesives are thermoset polymers comprising the reaction product of isocyanate terminated polyester urethane and tetrabromobisphenol A. Preferred coatings are the reaction product of brominated acrylated epoxy oligomer and bis(2-chloroethyl) vinyl phosphonate.

U.S. Pat. No. 5,888,618 to David C. Martin describes in the Abstract thereof a fire-resistant retroreflective structure having an array of rigid retroreflective elements and a method for making the structure are disclosed. The retroreflective structure is formed of an array of rigid retroreflective elements having a first side and a second side. A transparent polymeric film is attached to the first side of the array of rigid retroreflective elements. A transparent fire-resistant outerlayer is attached to the transparent polymeric film. A flame-retardant layer is placed proximate to the second side of the array of rigid retroreflective elements. A fire-resistant polymer underlayer is attached to the flame-retardant layer. The fire resistant polymer underlayer can be bonded to the transparent polymeric film through the array of rigid retroreflective elements and the flame-retardant layer.

Commonly assigned co-pending U.S. Provisional Application Ser. No. 60/436,261 filed Jan. 6, 2003, entitled “Flame Retardant Polyester Resin Composition and Articles Formed Therefrom” which is hereby incorporated by reference herein in its entirety, describes in the Abstract thereof a flame retardant polyester resin composition including polyester containing phosphorus, preferably about 0.05 to about 1.5 weight % phosphorus based on the total weight of the composition, and about 0.2 to about 15 weight %, based on the total weight of the composition, of at least one platy inorganic material. The composition provides excellent flame retardant and anti-dripping properties, especially to oriented polyester film formed from the composition. The polyester may include additional phosphorus that is covalently bonded to the polymer, or physically incorporated into the polyester such as by means of masterbatch.

Commonly assigned co-pending U.S. application Ser. No. 10/685,263 filed Oct. 14, 2003, entitled “Smooth Co-extruded Polyester Film Including Talc and Method for Preparing the Same” which is hereby incorporated by reference herein in its entirety, describes in the Abstract thereof a co-extruded film including talc and a method for preparing the film includes a polyester resin containing talc. The films may be single layer films or multi-layered structures such as ABA or AB structured films. Multi-layered films have talc in at least the A layer of the multi-layered film. If talc is present in the B layer, the A layer preferably includes a greater percentage of talc relative to the percentage of talc present in said B layer. The method uses readily available, low cost talc as an additive to achieve a co-extruded polyester film having simultaneously reduced transparency and reduced gloss to provide a translucent polyester film.

The disclosures of each of the foregoing are each totally incorporated by reference herein in their entireties. The appropriate components and process aspects of the each of the foregoing may be selected for the present compositions and processes in embodiments thereof.

There are times when a clear and smooth flame retardant base polyester film is desired. Further, there remains a need in the art for base films providing improved clarity, flame retardancy, and mechanical properties over currently available materials and for a method to prepare such films at a price that is commercially viable.

### SUMMARY

The present disclosure provides in embodiments thereof a metallized flame retardant polyester film comprising a base film having a selected level of phosphorous, the selected level of phosphorous being a minimum amount of phosphorous required to impart flame retardancy to the metallized flame retardant polyester film; and wherein the base film is metallized on at least one side of the base film.

In embodiments, the metallized flame retardant polyester film provides anti-dripping properties such as the following characteristics when subjected to the UL 94 flammability test for thin films: about 0% of the specimen drips flaming particles and ignites the cotton positioned 300 millimeters below; less than or equal to about 25% of the specimen burns to a 125 millimeter mark of the specimen; average after flame times t1 and t2 of the UL 94 test are less than about 30 seconds; and average minimum elemental phosphorus composition is larger than about 0.40% by total weight of the base film.

The disclosure further provides in embodiments thereof a method for preparing a metallized flame retardant polyester film comprising: providing a base film having a selected level of phosphorous, the selected level of phosphorous being a minimum amount of phosphorous required to impart flame retardancy to the metallized flame retardant polyester film; and metallizing the base film is metallized on at least one side of the base film.

The disclosure further provides in embodiments a method for preparing a metallized flame retardant polyester film comprising: co-extruding a base film comprising at least two film layers; providing varying levels of phosphorous to each of the at least two base film layers; wherein the varying levels of phosphorous comprise the minimum amount of phosphorous required to impart flame retardancy to the co-extruded flame retardant multi-layer film.

In aspects, the disclosure provides a metallized anti-dripping flame retardant film having varying levels of phosphorous loading and a method for producing the same. The film can be monolayer or multi-layer. When the film is multilayer, the level of phosphorus loading can be different. By selectively varying the phosphorous loading, film processing is enhanced and a flame retardant film is produced more economically than currently available flame retardant films.

In embodiments, the present flame retardant multi-layer film comprises at least two film layers comprising varying levels of phosphorous in the individual film layers with the varying levels of phosphorous being the minimum amount of phosphorous required to impart flame retardancy to the co-extruded flame retardant multi-layer film. In embodiments, the outer most layer or layers of the film comprise higher levels of phosphorous than then inner most layer or layers. The inner layer, or layers, may be phosphorous free. In this way, flame retardant properties are imparted to the film while minimizing the use of costly phosphorous.

In embodiments, the present method for preparing a co-extruded flame retardant multi-layer film comprises co-extruding at least two film layers; providing varying levels of phosphorous to one or more of the at least two film layers; wherein the varying levels of phosphorous comprise the minimum amount of phosphorous required to impart flame retardancy to the co-extruded flame retardant multi-layer film.

For example, the co-extruded flame retardant multi-layer film may comprise a two-layer film comprising a first layer and a second layer wherein the first layer comprises a first amount of phosphorous and the second layer comprises a second amount of phosphorous, wherein the first amount of phosphorous in the first layer is greater than the second amount of phosphorous in the second layer. The second layer can be phosphorous-free (i.e., comprise about 0% phosphorous).

For example, the co-extruded flame retardant multi-layer film may comprise a three-layer film comprising a first outer layer, an inner layer, and a second outer layer, the inner layer being disposed between the first and second outer layers. In this embodiment, the first outer layer comprises a first amount of phosphorous, the inner layer comprises a second amount of phosphorous, and the second outer layer comprises a third amount of phosphorous. For example, the first amount of phosphorous in the first outer layer is, in embodiments, greater than the second amount of phosphorous in the inner layer or the third amount of phosphorous in the second outer layer. Further, for example, one or both of the inner layer and the second outer layer may be phosphorous-free.

In yet another embodiment, a co-extruded flame retardant multi-layer film comprises, for example, a three-layer film comprising a first outer layer, an inner layer, and a second outer layer, the inner layer being sandwiched between the first and second outer layers. For example, the first outer layer comprises a first amount of phosphorous, the inner layer comprises a second amount of phosphorous, and the second outer layer comprises a third amount of phosphorous, wherein the first amount of phosphorous in the first outer layer is greater than the second amount of phosphorous in the inner layer and the third amount of phosphorous in the second outer layer is greater than the second amount of phosphorous in the inner layer. Further, in embodiments, the inner layer may be phosphorous-free.

The present films possess excellent flame retardant and anti-dripping properties. The films provide economic advantages over current commercially available flame resistant films due to the present selective phosphorous loading in the outer film layer or layers thereby minimizing the use of costly phosphorous.

For many applications, polyester film is metallized with a thin layer of aluminum in vacuum. Metallizing can increase gas barrier properties of the film greatly. For some applications, metal helps to reflect the radiant heat in building applications. A smooth surface is preferred to achieve certain barrier and reflection properties. In the present disclosure, the flame retardant polyester film, after metallizing, has the characteristic of preventing dripping, serving a similar purpose as antidripping agents. The disclosure shows that PET film with sufficient flame retardancy can perform well when subject to the UL94 test. Otherwise, if flame retardancy is insufficient, metallizing will actually promote burning of the PET film. For example, a regular metallized PET will make the PET film less likely to pass the UL94 test because of the antidripping nature of the metal layer. Additional FR retardant and antidripping materials such as, but not limited to, talc may then be employed to enhance the flame retardant properties of the film.

These and other features and advantages of the invention will be more fully understood from the following description of certain specific embodiments of the invention.

### DESCRIPTION

Metallized flame retardant polyester films comprise a base film having a selected level of phosphorous, the selected level of phosphorous being a minimum amount of phosphorous required to impart flame retardancy to the metallized flame retardant polyester film; and wherein the base film is metallized on at least one side of the base film or wherein the base film is metallized on two sides. For example, co-extruded flame retardant multi-layer films in accordance with the present disclosure comprise, in embodiments, at least two film layers having varying levels of phosphorous in the individual film layers with the varying levels of phosphorous being selected to provide the minimum amount of phosphorous required to impart flame retardancy to the co-extruded flame retardant multi-layer film and wherein one or more layers of the multi layer film can be phosphorous free. In embodiments, the outer most layer or layers of the film comprise higher levels of phosphorous than then inner most layer or layers. The inner layer or layers may be phosphorous free. The films are prepared, for example, by co-extruding at least two film layers; providing varying levels of phosphorous to one or more of the at least two film layers. In further embodiments, the base film is a clear film, a halogenated film, or a combination thereof.

For example, the films may comprise in embodiments any aromatic homopolyester, copolyester, or a blend of copolyester and homopolyester. The polyester is a polymer of one or more dicarboxylic acids and one or more diols prepared by the usual polycondensation process. The dicarboxylic acid component of the polyester comprises one or more dicarboxylic acids or low alkyl diesters thereof. Examples of suitable dicarboxylic acids include, but are not limited to, terephthalic acid, isophthalic acid, phthalic acid, naphthalenedicarboxylic acids, succinic acid, sebacic acid, adipic acid, azelaic acid, and mixtures thereof. In a preferred embodiment, the dicarboxylic acid component of the polyester comprises an aromatic dicarboxylic acid. Most preferably, the film comprises polyethylene terephthalate (PET) resin or isophthalic acid modified PET (i-PET).

Diols suitable for use in the present composition include, but are not limited to, ethylene glycol, 1,3-propanediol, 1,4-butanediol, neopentyl glycol, 1,6-hexanediol, 1,4-cyclohexanedimethanol and mixtures thereof.

The phosphorous may comprise any phosphorous-containing monomer capable of being polymerized with the polyester resin. The phosphorus content can be incorporated into the polyester covalently or compounded into the polymer such as with masterbatch process. Chemically bonded phosphorous prevents bleeding of the flame retardant component to the surface. Covalently bonded phosphorus is incorporated into the polyester backbone or on the side chain pending from the polyester backbone.

The co-extruded multi-layer flame retardant films comprise in embodiments the polyester(s) of the dicarboxylic acid and diol components as described above and each layer may be the same or different in composition. The phosphorous content is provided in the different layers to affect the desired film qualities. In embodiments, the film comprises one or more outer layers having increased phosphorous loading over one or more inner layers. Typical multi-layer structures include, but are not limited to, formats such as AB, ABA, ABC, and ABCBA. For heat-sealing applications and for increasing metal bonding to the film, an outer layer may comprise a copolyester or a copolyester blend.

Other materials and additives conventionally employed in the manufacturing of polyester film may be included, if desired, in the present films. Such materials and additives include, but are not limited to, organic and inorganic additives. For example, organic additives, include, but are not limited to, antioxidants, UV absorbers, optical brighteners, dyes, pigments, UV absorbers, and anti-blocking agents. In embodiments, the polymer base film may comprise fillers such as silica, aluminum oxide, or calcium carbonate, to improve winding and handling of the film. There are no limitations as to the particular methods for incorporating these additives into the polymer. Incorporation may be accomplished, for example, by incorporating covalently, by incorporating during polymerization, or by masterbatch process.

In embodiments, the film layers comprise biaxially oriented polyester film. In embodiments, the films are metallized on one or both sides of the base film or base films.

In further embodiments, one or more of the film layers are coated such as with a material suitable for increasing adhesion such a material suitable for increasing adhesion of the base film to metal. Suitable coating materials include for example, but are not limited to, acrylic emulsions, epoxy emulsions, polyester dispersions, or mixtures thereof. Alternately, for example, the present film may comprise one or more coextruded film layers having a copolymer on the skin layer to increase adhesion such as to increase adhesion to metal.

### EXAMPLES

Selected aspects will now be illustrated with reference to the following examples. Biaxially oriented polyester films were prepared in a polyester film line in accordance with these aspects set out in the Table 2 below. The films were stretched sequentially by stretching in machine direction (MD) followed by stretching in the transverse direction (TD). Base film and metallized examples were tested for flame retardancy according to UL94 protocol. The average flaming time, percentage of specimens burn to the 125 millimeter (mm) mark, and percentage of specimens drip and ignite cotton are also listed in Table 2.

The flame retardant (FR) resins used were polyphosphate-based copolyester commercially available from KoSa, Houston, Tex. Two grades of flame-retardant copolyester resin were used in this invention. FR8934 comprised a clear flame retardant grade copolyester resin with an IV of 0.66. Another copolyester, FR8984 had an IV of 0.68. The phosphorous (element) content for both copolyesters was about 0.69% by weight.

The talc used was a platy mineral-anhydrous magnesium silicate (3MgO.4SiO₂.H₂O) available from Luzenac America, Englewood Colo. Cimpact 710™ had a median diameter of 1.8 μm and 12.5 μm top size.

Laser+® polyethylene terephthalate, is a bottle grade copolyester commercially available from DAK Americas, Chadds Ford, Pa. It is believed to contain a small amount of isophthalate copolymer and was used in the compounding process. The intrinsic viscosity (IV) of this resin was 0.83.

In the film making process, several other Toray polyester resins were used. They included Toray PET resins F23M, F1CC, F119, and D2SY70. The first two resins (F23M and F1CC) were plain PET and the last two resins (F119 and D2SY70) contained silica particles.

The films were metallized in vacuum by evaporating and depositing aluminum metal on the film surfaces. The film can be optionally metallized on the other side when they are double-side metallized. The optical density of each metal layer was controlled to be about 2.5. Metallizing took place in either a bell jar metallizer or a regular production type metallizer. Bell jar metallizer is a laboratory metallizer where the film is metallized in sheet form. In a regular production type metallizer, the film is metallized in a roll form.

The films were tested for flame retardancy per UL94 protocol. Herein, the abbreviation “mm” is used to refer to millimeter or millimeters. In measuring flame retardancy of the film, a set of five test film specimens (200 mm×50 mm) were prepared and on each a line was marked across the specimen at 125 mm from one end (bottom) of the specimen. The longitudinal axis of each specimen was wrapped tightly around the longitudinal axis of a 12.7 mm in diameter mandrel to form a lapped cylinder 200 mm long with the 125 mm line exposed. The overlapping ends of the specimens were secured within the 75 mm portion above the 125 mm mark with pressure sensitive tape. The mandrel was then removed. Each test specimen was supported from the upper 6 mm by a clamp on a ring stand so that the upper end of the tube was closed to prevent any chimney effects. The lower end of the test specimen was situated 300 mm above a layer of dry surgical cotton. The test specimen was ignited using a 20 mm methane flame for about 3.0 seconds (s). The flame was then withdrawn from the test specimen and the duration of flaming (t1) was recorded. When flaming of the test specimen ceased, the methane flame was placed again under the specimen. After about 3.0 seconds, the test flame was withdrawn, and the duration of the flaming (t2) and glowing (t3) was noted. The materials classification for thin film per UL94 is as noted in Table 1. For film to obtain a good rating, not only the flaming and glowing time has to be short, but also the flame cannot drip and ignite the cotton. The thickness of the film was measured using a micrometer.

Base film (non-metallized) and metallized and non-metallized examples were tested for flame retardancy according to UL94 protocol. When the film is metallized on one side, the metal side is always rolled outside for the test. The average flaming time t1 and t2, percentage of specimens burn to the 125 mm mark, and percentage of specimens drip and ignite cotton are also listed in Table 2.

As discuss hereinbelow, the film thickness affects the flammability test results. One important contribution of the thickness is related to the heat-induced shrinkage, not burning itself. It was found that when a film was too thin (typically≦about 1 mil), the film shrank, instead of burning, to the 125 mm mark. UL94 does not take this into account. Therefore, close attention was paid to see if the film burned to or shrank to the 125 mm mark. However, even when there was no burning and the film only shrank to the 125 mm mark, it was still recorded as burned to the 125 mm mark.

TABLE 1
Materials Classifications per UL94 flammability test

| Criteria Conditions | VTM-0 | VTM-1 | VTM-2 |
|---|---|---|---|
| Afterflame time for each individual | ≦10 s | ≦30 s | ≦30 s |
| specimen t1 or t2 | | | |
| Total afterflame time for the set | ≦50 s | ≦250 s | ≦250 s |
| (t1 plus t2 for the 5 specimens) | | | |
| Afterflame plus after glow time for | ≦30 s | ≦60 s | ≦60 s |
| each individual specimen after the | | | |
| second flame application (t2 + t3) | | | |
| Afterflame or afterglow of any | No | No | No |
| specimen up to the holding clamp | | | |
| Cotton indicator ignited by flaming | No | No | Yes |
| particles or drips | | | |

### Example 1

Flame retardant copolyester FR8934 resin, PET F1CC resin and PET D2SY70 resin were mixed, extruded and cast into sheets of film in a polyester pilot-line. D2SY70 resin was introduced to control the coefficient of friction (COF) of the film and to improve handling since it contains silica particles. This film was further stretched to prepare biaxially oriented film having a film thickness of about 48 G (12 microns). This film was a monolayer film. The final film was clear and no discoloration of the film was noted. The phosphorous content was about 0.46%. The film was then metallized on one side using a bell jar metallizer. The metal layer had an optical density of about 2.5. The flame retardancy of the metallized film was tested per UL94.

The results are summarized in Table 2. The average after flame time t1 was about 6 seconds; the average after flame time t2 was about 2 seconds; about 25% of the specimens burned to the 125 mm mark; and about 0% of the specimens dripped flaming particles and ignited the cotton.

### Example 2

Flame retardant copolyester FR8934 resin, PET F1CC resin and PET D2SY70 resin were mixed, extruded and cast into sheets of film in a polyester pilot line. D2SY70 resin was introduced to control the coefficient of friction (COF) of the film and to improve handling since it contains silica particles. The film was further stretched to prepare biaxially oriented film having a film thickness of about 48 G (12 microns). The film was a monolayer film. The final film was clear and no discoloration of the film was noted. The phosphorous content was about 0.46%. The film was metallized first on one side and then on the opposite side in a regular production type metallizer where the film is metallized in a roll form. Each metal layer had an optical density of about 2.5. The flame retardancy of the metallized film was tested per UL94.

The results are summarized in Table 2. The average after flame time t1 was about 2 seconds; the average after flame time t2 was about 1 second; about 0% of the specimens burned to the 125 mm mark; and about 0% of the specimens dripped flaming particles and ignited the cotton.

### Example 3

Flame retardant copolyester FR8934 resin, PET F1CC resin and PET D2SY70 resin were mixed, extruded and cast into sheets of film in a polyester pilot line. D2SY70 resin was introduced to control the coefficient of friction (COF) of the film and to improve handling since it contains silica particles. The film was further stretched to prepare biaxially oriented film having a film thickness of about 200 G (50 microns). This film was an A/B/A multilayer film. The outer layers A were about 1.4 microns in thickness and contained about 0.64% elemental phosphorus by weight. The main layer B was about 47.2 microns in thickness and contained about 0.42% elemental phosphorus by weight. The average phosphorous content was about 0.43%. The final film was very clear and no discoloration of the film was noted. The film was metallized first on one side and then on the opposite side using a bell jar metallizer. Each metal layer had an optical density of about 2.5. The flame retardancy of the metallized film was tested per UL94.

The results are summarized in Table 2. The average after flame time t1 was about 13 seconds; the average after flame time t2 was about 3 seconds; about 0% of the specimens burned to the 125 mm mark; and about 0% of the specimens dripped flaming particles and ignited the cotton.

### Example 4

Flame retardant copolyester FR8984 resin, PET F23M resin and PET F119 resin were mixed, extruded and cast into sheets of film in a polyester film line. F119 resin was introduced to control the coefficient of friction (COF) of the film and to improve handling since it contains silica particles. The film was further stretched to prepare biaxially oriented film having a film thickness of about 110 G (27.5 microns). The film was an A/B/A multilayer film. The outer layers A were about 1.5 microns in thickness and contained about 0.62% elemental phosphorus by weight. The main layer B was about 24.5 microns in thickness and contained about 0.42% elemental phosphorus by weight. The average phosphorous content was about 0.44% by weight. The final film was very clear and no discoloration of the film was noted. The film was metallized on one side first and then on the opposite side using a bell jar metallizer. Each metal layer had an optical density of about 2.5. The flame retardancy of the metallized film was tested per UL94.

The results are summarized in Table 2. The average after flame time t1 was about 10 seconds; the average after flame time t2 was about 4 seconds; about 25% of the specimens burned to the 125 mm mark; and about 0% of specimens dripped flaming particles and ignited the cotton.

### Example 5

Into DAK Laser+® polyester resin, 30% by weight of talc was mixed into a co-rotating twin screw extruder. The extruded strands were cooled in a water trough and pelletized via cutting on a rotary cutting line. The resultant pellets were then admixed with copolyester FR8934 resin and PET F1CC resin. The pellets were extruded and cast into sheets of film in a polyester pilot line. This film was further stretched to prepare biaxially oriented film having a film thickness of about 92 G (23 microns). This film was an A/B/A multilayer film. The outer layers A were about 2.0 microns in thickness and contained about 0.62% elemental phosphorus and 3.0% talc by weight. The main layer B was about 19.0 microns in thickness and contained about 0.42% elemental phosphorus and 2.0% talc by weight. The average phosphorous content was about 0.45%. The final film had semigloss surfaces and no discoloration of the film was noted. The film was then metallized on one side using a bell jar metallizer. The metal layer had an optical density of about 2.5. The flame retardancy of the metallized film was tested per UL94.

The results are summarized in Table 2. The average after flame time t1 was about 5 seconds; the average after flame time t2 was about 0.3 seconds; about 0% of the specimens burned to the 125 mm mark; and about 0% of specimens dripped flaming particles and ignited the cotton.

### Comparative Example 1

Flame retardant copolyester FR8934 resin, PET F1CC resin and PET D2SY70 resin were mixed, extruded and cast into sheets of film in a polyester pilot line. D2SY70 resin contains silica particles and was introduced to control the coefficient of friction (COF) of the film and to improve handling. This film was further stretched to prepare biaxially oriented film having a film thickness of about 48 G (12 microns). This film was a monolayer film. The final film was clear and no discoloration of the film was noted. The phosphorous content was about 0.46%. The flame retardancy of the base film was tested per UL94.

The results are summarized in Table 2. The average after flame time t1 was about 0 seconds; the average after flame time t2 was about 0 seconds; about 100% of the specimens burned to the 125 mm mark; and about 20% of specimens dripped flaming particles and ignited the cotton.

### Comparative Example 2

A 92G plain polyester film with no flame retardant component (0% phosphorous, Toray Lumirror F65 film) was metallized on one side first and then on the other side using a bell jar metallizer. Each metal layer had an optical density of about 2.5. The flame retardancy of the metallized film was tested per UL94.

The results are summarized in Table 2. The average after flame time t1 was about 8 seconds; about 100% of the specimens burned to the 125 mm mark; and about 100% of specimens dripped flaming particles and ignited the cotton.

### Comparative Example 3

Flame retardant copolyester FR8934 resin, PET F1CC resin and PET D2SY70 resin were mixed, extruded and cast into sheets of film in a polyester pilot line. D2SY70 resin was introduced to control the coefficient of friction (COF) of the film and to improve handling since it contains silica particles. This film was further stretched to prepare biaxially oriented film having a film thickness of about 200 G (50 microns). This film was an A/B/A multilayer film. The outer layers A were about 1.4 microns in thickness and contained about 0.64% elemental phosphorus by weight. The main layer B was about 47.2 microns in thickness and contained about 0.42% elemental phosphorus by weight. The average phosphorous content was about 0.43%. The final film was very clear and no discoloration of the film was noted. The flame retardancy of the plain film was tested per UL94.

The results are summarized in Table 2. The average after flame time t1 was about 0 seconds; the average after flame time t2 was about 0 seconds; about 0% of the specimens burned to the 125 mm mark; and about 40% of specimens dripped flaming particles and ignited the cotton.

### Comparative Example 4

Flame retardant copolyester FR8934 resin, PET F1CC resin and PET D2SY70 resin were mixed, extruded and cast into sheets of film in a polyester pilot line. D2SY70 resin was introduced to control the coefficient of friction (COF) of the film and to improve handling since it contains silica particles. This film was further stretched to prepare biaxially oriented film having a film thickness of about 48 G (12 microns). This film was an A/B/A multilayer film. The outer layers A were about 1.0 micron in thickness and contained about 0.66% elemental phosphorus by weight. The main layer B was about 10.0 microns in thickness and contained about 0.07% elemental phosphorus by weight. The average phosphorous content was about 0.17%. The final film was very clear and no discoloration of the film was noted. The film was then metallized on one side using a bell jar metallizer. The metal layer had an optical density of about 2.5. The flame retardancy of the metallized film was tested per UL94.

The results are summarized in Table 2. The average after flame time t1 was about 3 seconds; about 100% of the specimens burned to the 125 mm mark; and about 0% of specimens dripped flaming particles and ignited the cotton.

TABLE 2
Film structure and flammability test results per UL94

| | | | | | | | | | | | Percent of |
|---|---|---|---|---|---|---|---|---|---|---|---|
| | | | | | | | | Aver- | Aver- | Percent of | specimens |
| | | | | | Layer | | Average | age | age | specimens | drip flaming |
| | Total | | Metal- | Film | thickness | | Phosphorus | t1 | t2 | burn to 125 | particles & |
| | thickness | | lized | structure | (μm) | Phosphorus % | % | (s) | (s) | mm mark | ignite cotton |
| Example 1 | 48G | (12 μm) | Single- | Monolayer | 12 | 0.46 | 0.46 | 6 | 2 | 25 | 0 |
| | | | side | | | | | | | | |
| Example 2 | 48G | (12 μm) | Double- | Monolayer | 12 | 0.46 | 0.46 | 2 | 1 | 0 | 0 |
| | | | side | | | | | | | | |
| Example 3 | 200G | (50 μm) | Double- | A/B/A | 1.4/47.2/1.4 | 0.64/0.42/0.64 | 0.43 | 13 | 3 | 0 | 0 |
| | | | side | | | | | | | | |
| Example 4 | 110G | (27.5 μm) | Single- | A/B/A | 1.5/24.5/1.5 | 0.62/0.42/0.62 | 0.44 | 10 | 4 | 25 | 0 |
| | | | side | | | | | | | | |
| Example 5 | 92G | (23 μm) | Single- | A/B/A | 2.0/19.0/2.0 | 0.62/0.42/0.62 | 0.45 | 5 | 0.3 | 0 | 0 |
| | | | side | | | | | | | | |
| Comparative | 48G | (12 μm) | None | Monolayer | 12 | 0.46 | 0.46 | 0 | 0 | 100 | 20 |
| Example 1 | | | | | | | | | | | |
| Comparative | 92G | (23 μm) | Double- | Monolayer | 23 | 0 | 0 | 8 | — | 100 | 100 |
| Example 2 | | | side | | | | | | | | |
| Comparative | 200G | (50 μm) | None | A/B/A | 1.4/47.2/1.4 | 0.64/0.42/0.64 | 0.43 | 0 | 0 | 0 | 40 |
| Example 3 | | | | | | | | | | | |
| Comparative | 48G | (12 μm) | Single | A/B/A | 1.0/10.0/1.0 | 0.66/0.07/0.66 | 0.17 | 3 | — | 100 | 0 |
| Example 4 | | | | | | | | | | | |

Film thickness affects the UL94 test results. The thicker the film, the more difficult it is for the film to ignite. However, one of the most important contributions of the film thickness is related to the heat-induced shrinkage, not burning itself We found that when a base film was very thin (typically ≦ca. 1 mil), the film typically shrank, not necessary burned, to the 125 mm mark. The UL94 test does not take this into account. Therefore, in the test of the present disclosure, close attention was paid to see if the film burned to or shrank to the 125 mm mark. However, if there was no burning and the film only shrank to the 125 mm, it was still recorded as burned to 125 mm mark.

Although the metal layer is very thin (ca. 200 angstroms for optical density of 2.5), the thickness is sufficient to prevent dripping and thermal shrinkage when burning. While not wishing to be bound by theory, the aluminum oxide layer (oxidation product of aluminum) may help to hold the burning film together.

Although an aluminum/aluminum oxide layer, for example, increases the barrier of the film, under the UL94 testing conditions, the barrier property is not believed to play an important role. Metallizing itself will actually make the final film easier to burn than the base film because, for example, aluminum itself is believed to burn under these conditions. Additionally, if the burning film is not dripping, the flame will be left on the film longer, which makes the burning time longer. For a film that drips flame, the whole flame usually drops down to the cotton below, and ignites the cotton. But the burning at film will stop at a relatively short time. UL94 rates all the film VTM2 as long as the dripping flame ignites the cotton, regardless of the burning time. It is only when the cotton is not ignited that the film can be rated either VTM1 or VTM0, depending on burning time.

Because aluminum metal itself actually burns, we use appropriate flame retardant film for metallizing. We have found that only film that has certain minimum flame retardancy can be used for metallizing applications.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A metallized flame retardant polyester film comprising:
a base film having a selected level of phosphorous, the selected level of phosphorous being a minimum amount of phosphorous required to impart flame retardancy to the metallized flame retardant polyester film; and
wherein the base film is metallized on at least one side of the base film.

2. The metallized flame retardant polyester film of claim 1, wherein a film specimen comprising the film of claim 1 provides the following characteristics when subjected to the UL 94 flammability test for thin films
about 0% of the specimen drips flaming particles and ignites the cotton;
less than or equal to about 25% of the specimen burns to a 125 millimeter mark of the test specimen;
average after flame times t1 and t2 of the UL 94 test are less than about 30 seconds; and
average minimum elemental phosphorus composition is larger than about 0.40% by total weight of the base film.

3. The metallized flame retardant polyester film of claim 1, wherein the base film is a clear film.

4. The metallized flame retardant polyester film of claim 1, wherein the base film is metallized on one side.

5. The metallized flame retardant polyester film of claim 1, wherein the base film is metallized on two sides.

6. The metallized flame retardant polyester film of claim 1, wherein the base film is coated with a material suitable for increasing adhesion.

7. The metallized flame retardant polyester film of claim 1, wherein the base film is coated with a material suitable for increasing adhesion of the base film to metal.

8. The metallized flame retardant polyester film of claim 1, wherein the base film is a multi-layer film; and
wherein one layer of the multi-layer base film is phosphorous free.

9. The metallized flame retardant polyester film of claim 1, wherein the base film comprises a two layer film comprising a first layer and a second layer; and
wherein the amount of phosphorous loading in the first layer is greater than the amount of phosphorous loading in the second layer.

10. The metallized flame retardant polyester film of claim 7, wherein the second layer is phosphorous free.

11. The metallized flame retardant polyester film of claim 1, wherein the base film is a multi-layer film comprising:
a first outer layer;
an inner layer; and
a second outer layer;
the inner layer being disposed between the first and second outer layers;
wherein the first outer layer comprises a first amount of phosphorous;
the inner layer comprises a second amount of phosphorous;
the second outer layer comprises a third amount of phosphorous;
the first amount of phosphorous in the first outer layer being greater than the second amount of phosphorous in the inner layer; and
the first amount of phosphorus in the first outer layer being greater than the third amount of phosphorous in the second outer layer.

12. The metallized flame retardant polyester film of claim 1, wherein the base film is a multi-layer film comprising:
a first outer layer;
an inner layer; and
a second outer layer;
the inner layer being disposed between the first and second outer layers; and
wherein one or both of the inner layer and the second outer layer are phosphorous-free.

13. The metallized flame retardant polyester film of claim 1, wherein the base film is a multi-layer film comprising:
a first outer layer;
an inner layer;
a second outer layer;
the inner layer being disposed between the first outer layer and the second outer layer;
wherein the first outer layer comprises a first amount of phosphorous;
the inner layer comprises a second amount of phosphorous;
the second outer layer comprises a third amount of phosphorous;
wherein the first amount of phosphorous in the first outer layer is greater than the second amount of phosphorous in the inner layer;
the third amount of phosphorous in the second outer layer is greater than the second amount of phosphorous in the inner layer.

14. The metallized flame retardant polyester film of claim 11, wherein the inner layer is phosphorous-free.

15. The metallized flame retardant polyester film of claim 1, wherein the base film comprises an aromatic homopolyester, copolyester, or mixtures thereof.

16. The metallized flame retardant polyester film of claim 1, wherein the base film comprises polyethylene terephthalate, isophthalic polyethylene terephthalate, or mixtures thereof.

17. The metallized flame retardant polyester film of claim 1, wherein the base film comprises a multi-layer film; and
wherein at least one layer of the multi-layer film comprises an aromatic homopolyester, copolyester, or mixtures thereof.

18. A method for preparing a metallized flame retardant polyester film comprising:
providing a base film having a selected level of phosphorous, the selected level of phosphorous being a minimum amount of phosphorous required to impart flame retardancy to the metallized flame retardant polyester film; and
metallizing the base film is metallized on at least one side of the base film.

19. The method for preparing a metallized flame retardant polyester film of claim 18, further comprising:
co-extruding a base film comprising at least two film layers;
providing varying levels of phosphorous to each of the at least two base film layers;
wherein the varying levels of phosphorous comprise the minimum amount of phosphorous required to impart flame retardancy to the co-extruded flame retardant multi-layer film.

20. The method of claim 18, further comprising:
metallizing the base film on one side.

21. The method of claim 18, further comprising:
metallizing the base film on two sides.

22. The method of claim 18, wherein the base film comprises two layers; and
wherein one layer of the base film is phosphorous free.

23. The method of claim 18, wherein the base film comprises a first layer and a second layer; and
wherein the amount of phosphorous loading in the first layer is greater than the amount of phosphorous loading in the second layer.

24. The method of claim 23, wherein said second layer is phosphorous free.

25. The method of claim 18, wherein the base film comprises a multi-layer film comprising:
a first outer layer;
an inner layer; and
a second outer layer;
the inner layer being disposed between the first outer layer and the second outer layer;
wherein the first outer layer comprises a first amount of phosphorous;
the inner layer comprises a second amount of phosphorous;
the second outer layer comprises a third amount of phosphorous;
the first amount of phosphorous in the first outer layer being greater than the second amount of phosphorous in the inner layer or the third amount of phosphorous in the second outer layer.

26. The method of claim 25, wherein one or both of the inner layer and the third outer layer are phosphorous-free.

27. The method of claim 18, wherein the base film comprises a multi-layer film comprising:
a first outer layer;
an inner layer;
a second outer layer;
the inner layer being disposed between the first outer layer and the second outer layer;
wherein the first outer layer comprises a first amount of phosphorous;
the inner layer comprises a second amount of phosphorous;
the second outer layer comprises a third amount of phosphorous;
wherein the first amount of phosphorous in the first outer layer is greater than the second amount of phosphorous in the inner layer; and
the third amount of phosphorous in the second outer layer is greater than the second amount of phosphorous in the inner layer.

28. The method of claim 27, wherein the inner layer is phosphorous-free.

29. The method of claim 18, wherein the base film is a halogenated film.

30. The method of claim 18, wherein the base film comprises polyethylene terephthalate, isophthalic polyethylene terephthalate, or mixtures thereof.

31. The method of claim 18, wherein the base film comprises a multi-layer film; and
wherein at least one layer of the multi-layer film comprises an aromatic homopolyester, copolyester, or mixtures thereof.

32. The method of claim 18, wherein the base film is coated with a material suitable for increasing adhesion.

33. The method of claim 18, wherein the base film is coated with a material suitable for increasing adhesion of the base film to metal.
